(19) United States
(12) Patent Application Publication
(10) Pub. No.: US 2021/0193036 A1
(43) Pub. Date: Jun. 24, 2021

(54) PIXEL UNIT, ARRAY SUBSTRATE AND DISPLAY TERMINAL

(71) Applicant: SHENZHEN ROYOLE TECHNOLOGIES CO., LTD., Shenzhen (CN)

(72) Inventors: Qiangcan HUANG, Shenzhen (CN); Ji Ha KIM, Shenzhen (CN)

(21) Appl. No.: 17/132,787

(22) Filed: Dec. 23, 2020

(30) Foreign Application Priority Data
Dec. 23, 2019 (CN) 201911341155.0

(51) Int. Cl. G09G 3/3233

(52) U.S. Cl. CPC G09G 3/3233; G09G 2330/021; G09G 2300/0819

(57) ABSTRACT

A pixel unit includes a drive unit, a display unit, a threshold compensation unit and a reset unit. The drive unit is configured to provide a drive current to the display unit in according to an emission signal received and image data received during a display phase to drive the display unit to perform image display. The reset unit is configured to write a reset voltage to the drive unit according to a reset signal during a reset phase to reset the drive unit. The threshold compensation unit is configured to provide a compensation voltage to the drive unit during a voltage compensation phase under the control of a second scan signal; the voltage compensation phase and the reset phase overlap partially. An array substrate and a display terminal both of which include the pixel unit are further provided.

### CROSS-REFERENCE TO RELATED APPLICATIONS

This application claims priority to China Patent Application No. 201911341155.0, filed on Dec. 23, 2019, the content of which is hereby incorporated by reference in its entirety.

### TECHNICAL FIELD

The present disclosure relates to a field of display drive, in particular to a pixel unit, an array substrate and a display terminal.

### BACKGROUND

When a self-luminous display panel displays images, a scanning drive circuit and a data drive circuit are provided to drive pixel unit arrays to perform an image display. In detail, the scanning drive circuit provides gate scan signals and emission scan signals, and the data drive circuit provides image data signals, and the image data signals coordinate with the gate scan signals and the emission scan signals to drive the pixel unit arrays located in an image display area to perform the image display.

Each pixel unit includes a display unit for performing the image display and a plurality of driving elements for driving the display unit, and the plurality of driving units include thin-film transistors and capacitors. When the thin-film transistors and the capacitors in the pixel unit provide drive currents for the display unit to drive the display unit for the image display, since there are residual charges in some of the driving elements during the display of the previous frame image, so that image data of the current frame image cannot be accurately loaded, and therefore the pixel units cannot accurately perform the display of the image data during the display of the current frame image.

### SUMMARY

To solve the above problems, the present disclosure provides a pixel unit with better display effect.

The present disclosure provides a pixel unit, which includes a drive unit, a display unit, a threshold compensation unit and a reset unit, the pixel unit receives and displays image data in a scanning cycle within a display period of the n-th frame image, and n is a nature number greater than 1. The drive unit is electrically connected to the display unit and is configured to provide a drive current to the display unit in accordance with an emission signal received and image data received during a display phase of the scanning cycle to drive the display unit to perform image display. The reset unit is electrically connected to the drive unit and is configured to write a reset voltage to the drive unit according to a reset signal during a reset phase of the scanning cycle to reset the drive unit. The threshold compensation unit is electrically connected to the drive unit and is configured to provide a compensation voltage to the drive unit during a voltage compensation phase of the scanning cycle under the control of a second scan signal; wherein, the compensation voltage is configured to compensate for a voltage drift generated by the drive unit when the drive unit provides the drive current to the display unit. The voltage compensation phase and the reset phase overlap partially.

The present disclosure further provides an array substrate, the array substrate includes a display area, and the display area includes the pixel unit as described above.

The present disclosure further provides a display terminal, and the display terminal includes the array substrate as described above.

Compared with the existing technology, the P-type thin-film transistors and the N-type thin-film transistors are used in the drive unit, the compensation unit, the auxiliary unit and the data write unit, and at the same time, the reset unit is added in the pixel unit to reset the drive unit. Thus, not only the leakage current of the pixel unit is reduced, but also the voltage drift of the pixel unit and the display unit can be accurately suppressed, and the power consumption is effectively reduced while the display effect is improved.

Furthermore, the transistors in the drive unit are all P-type low temperature polycrystalline oxide transistors, and the data write unit, the auxiliary unit and the compensation unit use the N-type metal oxide thin-film transistors. Thus, the leakage current of the pixel unit is small overall, and the voltage drift of the pixel unit itself and the display unit can be accurately suppressed, which can effectively reduce the power consumption and have a better display effect.

Furthermore, the P-type low temperature polycrystalline oxide transistor used in the drive unit has a strong drive ability, which can make the display unit quickly adapt to the refresh rate of different image data displayed at high and low speeds when performing image display.

### BRIEF DESCRIPTION OF THE ACCOMPANYING DRAWINGS

In order to more clearly explain the technical solutions of the embodiments of the present disclosure, the drawings required in the embodiments will be briefly introduced below. Obviously, the drawings in the following description are some embodiments of the present disclosure. In terms of technicians, other drawings can be obtained based on these drawings without any creative work.

FIG. 1 is a side-structure diagram of a display terminal according to one embodiment of the present disclosure.

FIG. 2 is a planar diagram of an array substrate of a display panel as shown in FIG. 1.

FIG. 3 is a circuit block diagram of a pixel unit in the display panel as shown in FIG. 2 according to a first embodiment of the present disclosure.

FIG. 4 is a circuit structure diagram of the pixel unit as shown in FIG. 3.

FIG. 5 is a timing diagram during a display process of one frame image by the pixel unit as shown in FIG. 4.

FIG. 6 is a circuit block diagram of a pixel unit in the display unit as shown in FIG. 2 according to a second embodiment of the present disclosure.

FIG. 7 is a circuit structure diagram of the pixel unit as shown in FIG. 6.

FIG. 8 is a timing diagram during a display process of one frame image by the pixel unit as shown in FIG. 7.

FIG. 9 is a curve diagram of a current flowing through a display unit of the pixel unit under the action of different threshold voltages as shown in FIG. 7.

FIG. 10 is a curve diagram of a current of the pixel unit flowing through the display unit in three frames as shown in FIG. 7.

FIG. 11 is a circuit block diagram of a pixel unit in the display panel as shown in FIG. 2 according to a third embodiment of the present disclosure.

FIG. 12 is a circuit structure diagram of the pixel unit as shown in FIG. 11.

FIG. 13 is a timing diagram during a display process of one frame image by the pixel unit as shown in FIG. 12.

FIG. 14 is a diagram of circuit working condition of the pixel unit in a non-overlapping phase during a reset phase as shown in FIG. 12.

FIG. 15 is a diagram of circuit working condition of the pixel unit in an overlapping phase during the reset phase as shown in FIG. 12.

FIG. 16 is a diagram of circuit working condition of the pixel unit in a non-overlapping phase during a voltage compensation phase as shown in FIG. 12.

FIG. 17 is a diagram of circuit working condition of the pixel unit during a data writing phase as shown in FIG. 12.

FIG. 18 is a diagram of circuit working condition of the pixel unit during a display phase as shown in FIG. 12.

FIG. 19 is a curve diagram of a current flowing through the display unit of the pixel unit under the action of different threshold voltages as shown in FIG. 12.

FIG. 20 is a curve diagram of a current of the pixel unit flowing through the display unit in three frames as shown in FIG. 12.

### DETAILED DESCRIPTION OF ILLUSTRATED EMBODIMENTS

The technical solutions in the embodiments of the present disclosure will be described clearly and completely with reference to the drawings in the embodiments of the present disclosure. Obviously, the described embodiments are only a part of the embodiments of the present disclosure, but not all the embodiments. Based on the embodiments of the present disclosure, all other embodiments obtained by those of ordinary skill in the art without paying any creative work fall within the protection scope of the present disclosure.

The circuit structure and the working process of pixel units in a display terminal will be described in detail in combination with the drawings in the embodiments of the present disclosure.

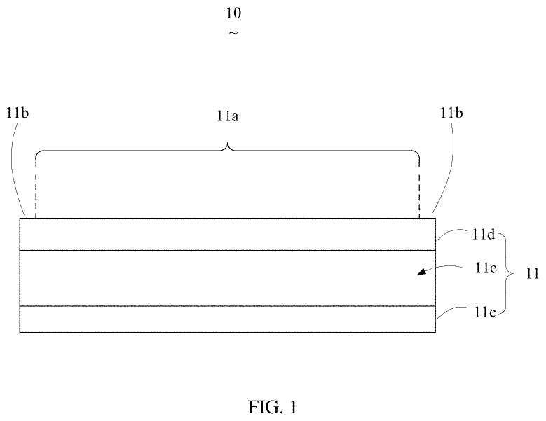

Please refer to FIG. 1, FIG. 1 is a side-structure diagram of a display terminal 10 according to one embodiment of the present disclosure. As shown in FIG. 1, the display terminal 10 includes a display panel 11 and other component parts (not shown in FIG. 1). The other component parts include a power module, a signal processor module, a signal sensor module, etc.

The display panel 11 includes a display area 11a for image display and a non-display area 11b. The display area 11a is configured to perform image display, that is, the display area 11a is used to display images. The non-display area 11b is arranged around the display area 11a, and is designed to be used for mounting other auxiliary parts or modules. Specifically, the display panel 11 further includes an array substrate 11c, an opposite substrate 11d, and a display medium layer 11e sandwiched between the array substrate 11c and the opposite substrate 11d. In this embodiment, a display medium in the display medium layer 11e is a Organic Electroluminescence Diode (OLED) material.

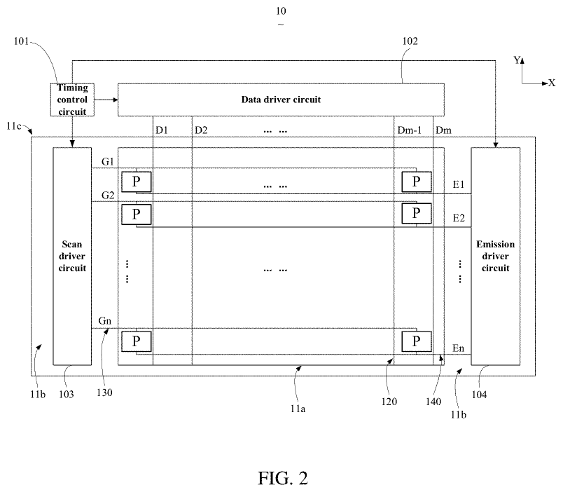

Please refer to FIG. 2, FIG. 2 is a planar structure diagram of the array substrate 11c of the display panel 11 as shown in FIG. 1. As shown in FIG. 2, the array substrate 11c includes m*n pixels P arranged in a matrix, m data lines 120, n scan lines 130, and n emission lines 140, and the m*n pixels P, the m data lines 120, the n scan lines 130, and the n emission lines 140 correspond to the position of the display area 11a. wherein, m and n are both natural numbers greater than 1.

The m data lines 120 are arranged in parallel along a second direction Y, and are separated by a first predetermined distance and insulated from each other. The n scan lines 130 are arranged in parallel along a first direction X, and are separated by a second predetermined distance and insulated from each other. The n emission lines 140 are arranged in parallel along the first direction X, and are separated by the second predetermined distance and insulated from each other. The n scan lines 130, the n emission lines 140 and the m data lines 120 are insulated from each other, and the first direction X is perpendicular to the second direction Y.

For the convenience of illustration, the m data lines 120 are respectively defined as D1, D2, . . . , Dm−1, Dm, in position order; the n scan lines 130 are respectively defined in position order as G1, G2, . . . , Gn; the n emission lines 140 are respectively defined as E1, E2, . . . , . . . , En in position order. Each pixel P is electrically connected to a scan line 130 and an emission line 140 both of which are extended along the first direction X and a data line 120 which is extended along the second direction Y, correspondingly.

The display terminal 10 further includes a timing control circuit 101, a data driver circuit 102, a scan driver circuit 103 and an emission driver circuit 104. The scan driver circuit 103, the timing control circuit 101, the data driver circuit 102 and the emission driver circuit 104 are used to drive the pixels P for image display cooperatively. The scan driver circuit 103, the data drive circuit 102, the time control circuit 101, and the emission driver circuit 104 are located on the array substrate 11c.

The data driver circuit 102 is electrically connected to the data lines 120 and is configured to transmit image data to be displayed to the pixels P in the form of data voltage by use of the plurality of data lines 120.

The scan driver circuit 103 is electrically connected to the scan lines 130 and is configured to output scan signals Gn to the pixels P through the scan lines 130 to control when the pixels P receive the image data. In detail, the scan driver circuit 103 can output the scan signals G1, G2, . . . , Gn to corresponding pixels P through the scan lines 130 (including the scan lines G1, G2, . . . , Gn arranged in position order) in accordance with a scanning cycle. For example, the scan driver circuit 103 output the scan signal G1 to the pixels P by use of the scan line G1, the scan driver circuit 103 output the scan signal G2 to the pixels P by use of the scan line G2, the scan driver circuit 103 output the scan signal G32 to the pixels P by use of the scan line G32, and the scan driver circuit 103 output the scan signal Gn to the pixels P by use of the scan line Gn.

The emission driver circuit 104 is electrically connected to the emission lines 140 and is configured to output emission signals En to the pixels P through the emission lines 140 to control when the pixels P emit light according to received image data. In detail, the emission driver circuit 104 can output the emission signals E1, E2, . . . , En to corresponding pixels P through the emission lines 140 (including the emission lines E1, E2, . . . , En arranged in position order) in accordance with the scanning cycle. For example, the emission driver circuit 104 outputs the emission signal E1 to the pixels P by use of the emission line E1, the emission driver circuit 104 outputs the emission signal E2 to the pixels P by use of the emission line E2, and the emission driver circuit 104 outputs the emission signal En to the pixels P by use of the emission line En.

The timing control circuit 101 is electrically connected to the data driver circuit 102, the scan driver circuit 103 and the emission driver circuit 104, respectively, and is configured to control working sequences of the data driver circuit 102, the scan driver circuit 103 and the emission driver circuit 104. That is, the timing control circuit 101 can output corresponding timing control signals to the scan driver circuit 103, the data driver circuit 102 and the emission driver circuit 104 to control when the scan signals Gn, the emission signal En and the image data Data are output.

In this embodiment, circuit elements in the scan driver circuit 103 and the pixels P in the display panel 11 are made in the display panel 11 by use of the same process, namely, the Gate Driver on Array (GOA) technology. Circuit elements in the emission driver circuit 104 and the pixels P in the display panel 11 are also made in the display panel 11 by use of the same process, namely, the Gate Driver on Array (GOA) technology.

It should be understandable that the display terminal 10 further includes other auxiliary circuits for jointly completing image display, such as, Graphics Processing Unit (GPU), power circuit, etc., which will not be repeated in this embodiment.

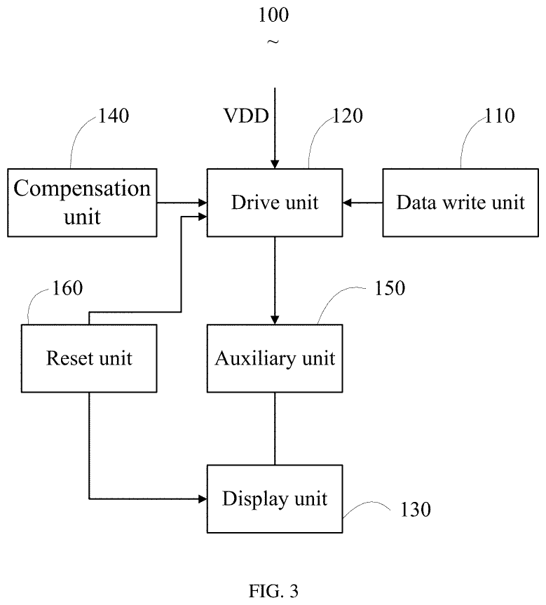

Please refer to FIG. 3, FIG. 3 is a circuit block diagram of a pixel unit in the display panel as shown in FIG. 2 according to a first embodiment of the present disclosure. As shown in FIG. 3, a pixel unit 100 includes a data write unit 110, a drive unit 120, a display unit 130, a compensation unit 140, an auxiliary unit 150 and a reset unit 160. In this embodiment, one scanning cycle during a display process of one frame image executed by the pixel unit 100 includes three sequential and continuous time phases of H1-H3, in detail, H1 is a reset phase, H2 is a data writing phase, and H3 is a display phase.

In this embodiment, the data write unit 110 is electrically connected to the drive unit 120, and is configured to write the image data Data to the drive unit 120 according to a first scan signal Gn during the data writing phase H2.

The drive unit 120 is electrically connected to the display unit 130 and is configured to provide a drive current to the display unit 130 in accordance with received emission signal En cooperated with the image data Data during the display phase H3 to drive the display unit 130 to emit light and perform the image display. In this embodiment, the display phase H3 follows the data writing phase H2, and does not overlap completely.

The compensation unit 140 is electrically connected to the drive unit 120, and is configured to provide a compensation voltage to the drive unit 120 in advance when the image data Data is written to the drive unit 120 during the data writing phase H2. In this embodiment, the compensation voltage is configured to compensate for a voltage drift generated by the drive unit 120 itself when the drive unit 120 provides the drive current to the display unit 130.

The auxiliary unit 150 is electrically connected between the display unit 130 and the drive unit 120, and is configured to be in an electrical cut-off state under the control of the emission signal En during the data writing phase to make the display unit 130 and the drive unit 120 disconnected, which therefore can prevent the image data Data transmission to the display unit 130 during a non-display phase and further avoid affecting the image display correctly. At the same time, the auxiliary unit 150 is in a conducting state under the control of the emission signal En during the display phase H3, making the display unit 130 and the drive unit 120 electrically connected to transmit the drive current to the display unit 130.

The reset unit 160 is electrically connected to the drive unit 120 and the display unit 130, and is configured to write a reset voltage to the drive unit 120 and the display unit 130 according to a reset signal during the reset phase H1, so that the drive unit 120 is in an initial drive voltage state and the display unit 130 is in an initial display voltage state. The reset unit 160 is further configured to eliminate the voltage and the current remaining in the drive unit 120 and the display unit 130 in a previous display phase, to ensure that each pixel unit 100 can accurately display the image data during each display phase of one frame images.

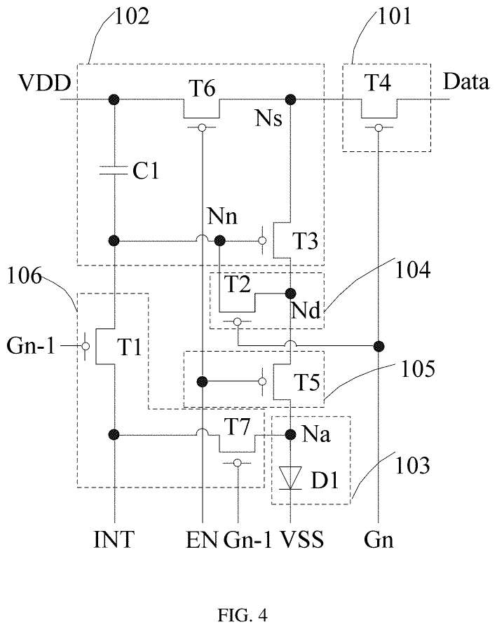

In detail, please refer to FIG. 4, FIG. 4 is a circuit structure diagram of the pixel unit 100 as shown in FIG. 3. As shown in FIG. 4, it should be noted that the pixel unit 100 is scanned and controlled by the scan signal output from the scan line Gn, and transistors in the pixel unit 100 are P-type transistors.

The data write unit 110 includes a fourth transistor T4 including a gate, a first end and a second end. The gate of the fourth transistor T4 is electrically connected to a first scan line Gn, the first end of the fourth transistor T4 is electrically connected to one of the data lines Dm, and the second end of the fourth transistor T4 is electrically connected to a first node Ns in the drive unit 120.

In this embodiment, the drive unit 120 includes a third transistor T3, a sixth transistor T3 and a first capacitor C1. The third transistor T3 includes a gate, a first end and a second end, and the gate of the third transistor T3 is electrically connected to a drive node Nn, the first end of the third transistor T3 is electrically connected to the first node Ns, and the second end of the third transistor T3 is electrically connected to a second node Nd. The first capacitor C1 is electrically connected between a drive voltage input end VDD and the drive node Nd. The drive voltage end VDD is configured to provide an emission drive voltage Vdd required by the display unit 130.

The sixth transistor T6 include a gate, a first end and a second end, and the gate of the sixth transistor T6 is electrically connected to the emission line En, the first end of the sixth transistor T6 is electrically connected to the drive voltage end VDD, an the second end of the sixth transistor T6 is electrically connected to the first node Ns.

In this embodiment, the display unit 130 includes an organic light-emitting diode (OLED) D1. The anode of the OLED D1 is electrically connected to a display node Na, and the cathode of the OLED D1 is electrically connected to a low reference voltage end VSS.

The compensation unit 140 includes a second transistor T2, and the second transistor T2 includes a gate, a first end, and a second end. The gate of the second transistor T2 is electrically connected to the first scan line Gn, the first end of the second transistor T2 is electrically connected to the drive node Nn, and the second end of the second transistor T2 is electrically connected to the second node Nd.

The auxiliary unit 150 includes a fifth transistor T5, and the fifth transistor T5 includes a gate, a first end and a second end. The gate of the fifth transistor T5 is electrically connected to the emission line En, the first end of the fifth transistor T5 is electrically connected to the second node Nd, and the second end of the fifth transistor T5 is electrically connected to the display node Na.

The reset unit 160 includes a first transistor T1 and a seventh transistor T7, and the first transistor T1 includes a gate, a first end and a second end. The gate of the first transistor T1 is electrically connected to a second scan line Gn−1, the first end of the first transistor T1 is electrically connected to a reset voltage end INT, and the second end of the first transistor T1 is electrically connected to the drive node Nn.

The seventh transistor T7 includes a gate, a first end and a second end. The gate of the seventh transistor T7 is electrically connected to the second scan line Gn−1, the first end of the seventh transistor T7 is electrically connected to the reset voltage end INT, and the second end of the seventh transistor T7 is electrically connected to the display node Na.

In this embodiment, the second scan line Gn−1 and the first scan line Gn are two adjacent scan lines, and can output the scan signals in two adjacent scanning cycles.

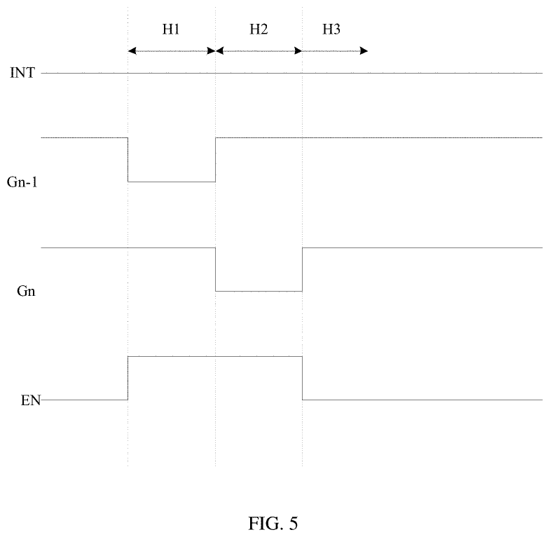

Please refer to FIG. 5, FIG. 5 is a timing diagram during a display process of one frame image by the pixel unit as shown in FIG. 4. As shown in FIG. 5, a curve graph corresponding to INT represents a voltage waveform of a reset voltage signal INT output from the reset voltage end INT. Gn−1 represents a voltage waveform of the second scan signal Gn−1 output from the second scan line Gn−1. Gn represents a voltage waveform of the first scan signal Gn output from the first scan line Gn. A curve graph corresponding to En represents a voltage waveform of the emission signal En output from the emission line En.

In the reset phase H1, the emission signal En is at a high level, the second scan signal Gn−1 is at a low level, and the first scan signal Gn is at the high level. Thus, the fifth transistor T5 and the sixth transistor T6 are in the cut-off state under the control of the emission signal En at the high level, the first transistor T1 and the seventh transistor T7 are in the conducting state under the control of the second scan signal Gn−1 at the low level, and the second transistor T2 and the fourth transistor T4 are in the cut-off state under the control of the first scan signal Gn at the high level. That is, the fifth transistor T5 and the sixth transistor T6 are switched off under the control of the emission signal En at the high level, the first transistor T1 and the seventh transistor T7 are switched on under the control of the second scan signal Gn−1 at the low level, and the second transistor T2 and the fourth transistor T4 are switched off under the control of the first scan signal Gn at the high level.

Furthermore, since the first transistor T1 and the seventh transistor T7 are in the conducting state under the control of the second scan signal Gn−1 at the low level, the reset voltage signal INT output from the reset voltage end INT is outputted to the drive node Nn and the display node Na in the drive unit 120, therefore effectively eliminating the residual voltage in the drive node Nn and the display node Na during the display process of the previous frame images and ensuring that the voltage of the drive node Nn and the display node Na will not affect the operation in the next stage.

In the data writing phase H2, the emission signal En is at the high level, the second scan signal Gn−1 is at the high level, and the first scan signal Gn is at the low level. Thus, the fifth transistor T5 and the sixth transistor T6 are in the cut-off state under the control of the emission signal En at the high level, the first transistor T1 and the seventh transistor T7 are in the cut-off state under the control of the second scan signal Gn−1 at the high level, and the second transistor T2 and the fourth transistor T4 are in the conducting state under the control of the first scan signal Gn at the low level. That is, the fifth transistor T5 and the sixth transistor T6 are switched off under the control of the emission signal En at the high level, the first transistor T1 and the seventh transistor T7 are switched off under the control of the second scan signal Gn−1 at the high level, and the second transistor T2 and the fourth transistor T4 are switched on under the control of the first scan signal Gn at the low level.

Furthermore, since the fourth transistor T4 is in the conducting state under the control of the first scan signal Gn at the low level, that is, the fourth transistor T4 is switched on under the control of the first scan signal Gn at the low level, a data voltage Vdata is transmitted to the first node Ns through the fourth transistor T4.

In addition, under the action of the reset voltage INT, the voltage of the drive node Nn is far less than the voltage of the first node Ns. That is, a gate voltage of the third transistor T3 is far less than that of the first end of the third transistor T3, so that the third transistor T3 is in the conducting state.

The second transistor T2 in the compensation unit 140 is in the conducting state under the control of the first scan signal Gn at the low level, at this point, the gate of the third transistor T3 is electrically connected to the second end of the third transistor T3, therefore forming a diode connection. Thus, at this point, the voltage VNn of the drive node Nn is charged by the data voltage Vdata through the third transistor T3; when the voltage VNn of the drive node Nn is charged to a voltage Vdata-Vth, the third transistor T3 is in the cut-off state, that is, the third transistor T3 is switched off, the data voltage Vdata stops charging the drive node Nn. Moreover, due to the non-mutagability of the first capacitor C1, the voltage VNn of the drive node Nn can maintain at the voltage Vdata-Vth. According to the above, the threshold voltage Vth of the third transistor T3 is written to the drive node Nn along with the data voltage Vdata. Wherein, Vth is the threshold voltage when the third transistor T3 in the conducting state.

In the display phase H3, the emission signal En is at the low level, the second scan signal Gn−1 is at the high level, and the first scan signal Gn is at the high level. Thus, the fifth transistor T5 and the sixth transistor T6 are in the conducting state under the control of the emission signal En at the low level, the first transistor T1 and the seventh transistor T7 are in the cut-off state under the control of the second scan signal Gn−1 at the high level, and the second transistor T2 and the fourth transistor T4 are in the cut-off state under the control of the first scan signal Gn at the high level. That is, the fifth transistor T5 and the sixth transistor T6 are switched on under the control of the emission signal En at the low level, the first transistor T1 and the seventh transistor T7 are switched off under the control of the second scan signal Gn−1 at the high level, and the second transistor T2 and the fourth transistor T4 are switched off under the control of the first scan signal Gn at the high level.

Furthermore, in the display phase H3, the data write unit 110 stops working, and the sixth transistor T6 are switched on under the control of the emission signal En at the low level, so that the emission drive voltage Vdd from the drive voltage end VDD is inputted to the first node Ns, and the voltage of the drive node Nn is less than the emission drive voltage Vdd. That is, the gate voltage of the third transistor T3 is less than the voltage applied on the first end of the third transistor T3, so that the third transistor T3 is in the conduction state.

In addition, since the fifth transistor T5 is in the conducting state under the control of the emission signal En at the low level, so that the emission drive voltage Vdd can be transmitted to the OLED D1 in the display unit 130 through the third transistor T3 and the fifth transistor T5.

At the same time, the drive current transmitted to the display unit 130 through the third transistor T3 is: Ids=½k(Vgs−Vth)\hat{ }2, wherein, K=μCox W/L, W is the width of a conducting channel of the third transistor T3, L is the length of the conducting channel, that is, K is a coefficient that is used to represent the size of the conducting channel, electron mobility and other relevant parameters of the third transistor T3.

Furthermore, Vgs is VNs−VNn=Vdd−(Vdata−Vth), then Vgs−Vth=Vdd−(Vdata−Vth)−Vth=Vdd−Vdata+Vth−Vth=Vdd−Vdata.

Obviously, There is no relationship between the drive current Ids used for the OLED D1 of the display unit 130 and the threshold voltage Vth of the third transistor T3. That is, the threshold voltage Vth of the third transistor T3 is offset during the display phase H3 by writing the threshold voltage Vth of the third transistor T3 to the drive node Nn in advance, and the voltage drift of the threshold voltage Vth of the third transistor T3 is eliminated, therefore preventing the luminance of the OLED D1 in the display unit 130 from being unable to reach a predetermined luminance due to the voltage drift the threshold voltage Vth of the third transistor T3.

It is found in studies that although the pixel unit 100 composed of all P-type thin-file transistors can eliminate the influence of the threshold voltage on the display unit, however, because the P-type thin-film transistors generally have large cut-off currents, resulting in leakage current in the drive node Nn, which is especially obvious at low frequencies, affecting the display effect.

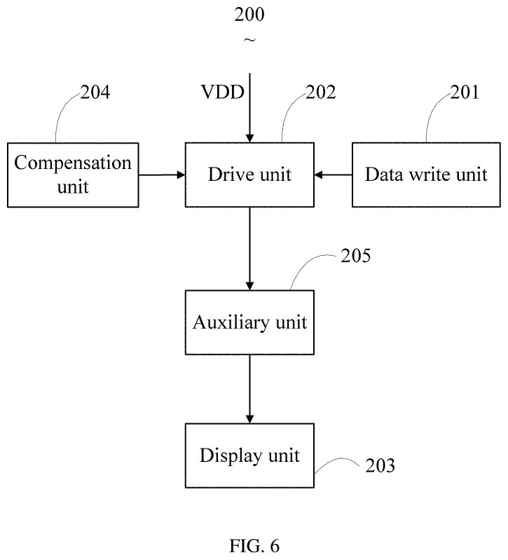

Please refer to FIG. 6, FIG. 6 is a circuit block diagram of a pixel unit in the display panel as shown in FIG. 2 according to a second embodiment of the present disclosure. As shown in FIG. 6, the pixel unit 200 includes a data write unit 201, a drive unit 202, a display unit 203, a compensation unit 204 and an auxiliary unit 205. In this embodiment, one scanning cycle during a display process of one frame image executed by the pixel unit 200 includes three sequential and continuous time phases of H21-H23. In detail, H21 is a voltage compensation phase, H22 is a data writing phase, and H23 is a display phase.

In this embodiment, the data write unit 201 is electrically connected to the drive unit 202, and is configured to write the image data Data to the drive unit 202 according to a first scan signal Gn during the data writing phase H22.

In this embodiment, the drive unit 202 is electrically connected to the display unit 203 and is configured to provide a drive current to the display unit 203 in accordance with received emission signal En cooperated with the image data Data during the display phase H23 to drive the display unit 203 to emit light and perform the image display.

In this embodiment, the compensation unit 204 is electrically connected to the drive unit 202, and is configured to provide a drive voltage and a compensation voltage to the drive unit 202 during the voltage compensation phase H21. In this embodiment, the compensation voltage is configured to compensate for a voltage drift generated by the drive unit 202 itself when the drive unit 202 provides the drive current to the display unit 203.

The auxiliary unit 205 is electrically connected between the display unit 203 and the drive unit 202, and is configured to be in an electrical cut-off state under the control of the emission signal En during the voltage compensation phase H21 and the data writing phase H22 to make the display unit 203 and the drive unit 202 be disconnected, which therefore can prevent the image data Data transmission to the display unit 203 during a non-display phase and further avoid affecting the image display correctly. At the same time, the auxiliary unit 205 is in a conducting state under the control of the emission signal En during the display phase H23, enabling the display unit 203 and the drive unit 202 electrically connected to transmit the drive current to the display unit 203.

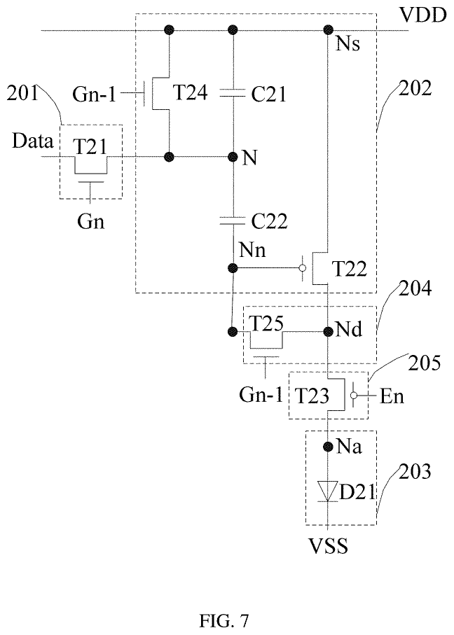

In detail, please refer to FIG. 7, FIG. 7 is a circuit structure diagram of the pixel unit 200 as shown in FIG. 6. As shown in FIG. 7, it should be noted that the pixel unit 200 is scanned and controlled by the scan signal output from the scan line Gn, and transistors in the pixel unit 200 include N-type transistors and P-type transistors.

The data write unit 201 includes a first transistor T21 including a gate, a first end and a second end. The gate of the first transistor T21 is electrically connected to the first scan line Gn, the first end of the first transistor T21 is electrically connected to a third node N, and the second end of the first transistor T21 is electrically connected to one of the data lines Dm. In this embodiment, the first transistor T21 is an N-type thin-film transistor.

In this embodiment, the drive unit 202 includes a first capacitor C21, a second capacitor C22 and a second transistor T22. The second transistor T22 is a P-type thin-film transistor.

The first capacitor C21 is electrically connected between a drive voltage input end VDD and the third node N.

The second capacitor C22 is electrically connected between the third node N and the drive node Nn.

The second transistor T22 includes a gate, a first end and a second end, and the gate of the second transistor T22 is electrically connected to the drive node Nn, the first end of the second transistor T22 is electrically connected to the first node Ns, and the second end of the second transistor T22 is electrically connected to a second node Nd.

The display unit 203 includes an OLED D21, the anode of the OLED D21 is electrically connected to the display node Na, and the cathode of the OLED D21 is electrically connected to the low reference voltage end VSS.

The compensation unit 204 includes a fourth transistor T24 and a fifth transistor T25. The fourth transistor T24 is an N-type thin-film transistor and includes a gate, a first end and a second end. The gate of the fourth transistor T24 is electrically connected to a second scan line Gn−1, the second end of the fourth transistor T24 is electrically connected to the drive voltage input end VDD, and the first end of the fourth transistor T24 is electrically connected to the third node N.

In this embodiment, the fifth transistor T25 is an N-type thin-film transistor and includes a gate, a first end and a second end. The gate of the fifth transistor T25 is electrically connected to the second scan line Gn−1, the second end of the fifth transistor T25 is electrically connected to the second node Nd, and the first end of the fifth transistor T25 is electrically connected to the drive node Nn.

The auxiliary unit 205 includes a third transistor T23, the third transistor T23 is a P-type thin-film transistor and includes a gate, a first end and a second end. The gate of the third transistor T23 is electrically connected to the emission line En, the first end of the third transistor T23 is electrically connected to the second node Nd, and the second end of the third transistor T23 is electrically connected to the display node Na.

In this embodiment, the second scan line Gn−1 and the first scan line Gn are two adjacent scan lines, and can output the scan signals in two adjacent scanning cycles.

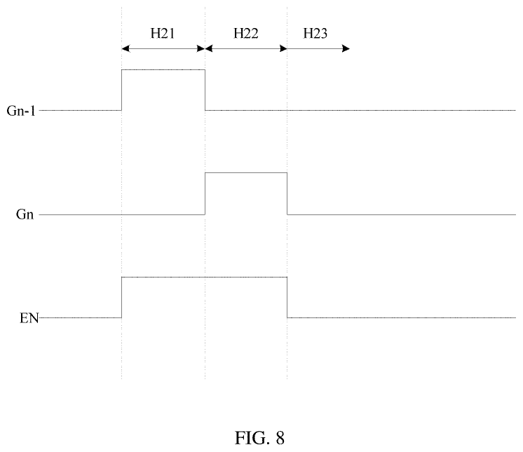

Please refer to FIG. 8, FIG. 8 is a timing diagram during a display process of one frame image by the pixel unit as shown in FIG. 7. As shown in FIG. 8, Gn−1 represents a voltage waveform of the second scan signal Gn−1 output from the second scan line Gn−1. Gn represents a voltage waveform of the first scan signal Gn output from the first scan line Gn. A curve graph corresponding to En represents a voltage waveform of the emission signal En output from the emission line En.

In the voltage compensation phase H21, the emission signal En is at a high level, the second scan signal Gn−1 is at the high level, and the first scan signal Gn is at a low level. Thus, the third transistor T23 is in a cut-off state under the control of the emission signal En at the high level, the fourth transistor T24 and the fifth transistor T25 are in a conducting state under the control of the second scan signal Gn−1 at the high level, and the first transistor T21 is in the cut-off state under the control of the first scan signal Gn at the low level. That is, the third transistor T23 is switched off under the control of the emission signal En at the high level, the fourth transistor T24 and the fifth transistor T25 are switched on under the control of the second scan signal Gn−1 at the high level, and the first transistor T21 is switched off under the control of the first scan signal Gn at the low level.

Furthermore, since the fourth transistor T24 is in the conducting state under the control of the second scan signal Gn−1 at the high level, the emission drive voltage Vdd from the drive voltage input end VDD is input to the third node N.

At the same time, in a normal working state, the voltage of the drive node Nn is less than the emission drive voltage Vdd applied to the first node Ns. That is, the gate voltage of the second transistor T22 is less than the voltage applied to the first end of the second transistor T22, so that the second transistor T22 is in the conducting state.

The fifth transistor T25 is in the conducting state under the control of the second scan signal Gn−1 at the high level, at this point, the gate of the fifth transistor T25 is electrically connected to the second end of the fifth transistor T25, therefore forming a diode connection. Thus, at this point, the voltage VNn of the drive node Nn is charged by the emission drive voltage Vdd through the second transistor T22; when the voltage VNn of the drive node Nn is charged to a voltage Vdd-Vth, the second transistor T22 is in the cut-off state, that is, the second transistor T22 is switched off, the emission drive voltage Vdd stops charging the drive node Nn. Moreover, due to the non-mutagability of the second capacitor C22, the voltage VNn of the drive node Nn is maintained at the voltage Vdd-Vth. Wherein, Vth is the threshold voltage when the second transistor T22 in the conducting state. It can be seen that the threshold voltage Vth of the second transistor T22 is written to the drive node Nn along with the emission drive voltage Vdd, that is, the emission drive voltage Vdd and the threshold voltage Vth of the second transistor T22 are both written to the drive node Nn.

In the data writing phase H22, the emission signal En is at the high level, the second scan signal Gn−1 is at the low level, and the first scan signal Gn is at the high level. Thus, the third transistor T23 is in the cut-off state under the control of the emission signal En at the high level, the fourth transistor T24 and the fifth transistor T25 are in the cut-off state under the control of the second scan signal Gn−1 at the low level, and the first transistor T21 is in the conducting state under the control of the first scan signal Gn at the high level. That is, the third transistor T23 is switched off under the control of the emission signal En at the high level, the fourth transistor T24 and the fifth transistor T25 are switched off under the control of the second scan signal Gn−1 at the low level, and the first transistor T21 is switched on under the control of the first scan signal Gn at the high level.

Furthermore, since the first transistor T21 is in the conducting state under the control of the first scan signal Gn at the high level, the data voltage Vdata is input to the third node N through the first transistor T21, enabling the voltage VN of the third node N to be Vdd-Vdata.

At the same time, the voltage VNn of the drive node Nn is affected by voltage changes of the third node N, the voltage VNn is changed to Vdd−Vth−(Vdd−Vdata), namely, the voltage VNn of the drive node Nn is Vdata−Vth.

In the display phase H23, the emission signal En is at the low level, the second scan signal Gn−1 is at the low level, and the first scan signal Gn is at the low level. Thus, the third transistor T23 is in the conducting state under the control of the emission signal En at the low level, the fourth transistor T24 and the fifth transistor T25 are in the cut-off state under the control of the second scan signal Gn−1 at the low level, and the first transistor T21 is in the cut-off state under the control of the first scan signal Gn at the low level. That is, the third transistor T23 is switched on under the control of the emission signal En at the low level, the fourth transistor T24 and the fifth transistor T25 are switched off under the control of the second scan signal Gn−1 at the low level, and the first transistor T21 is switched off under the control of the first scan signal Gn at the low level.

Furthermore, in the display phase H3, the data write unit 201 stops working, and the voltage of the drive node Nn is Vdata-Vth which is less than the emission drive voltage Vdd of the first node Ns. That is, the gate voltage of the second transistor T22 is less than the voltage applied on the first end of the second transistor T22, so that the second transistor T22 is in the conduction state.

In addition, since the third transistor T23 is in the conducting state under the control of the emission signal En at the low level, so that the emission drive voltage Vdd can be transmitted to the OLED D21 in the display unit 203 through the second transistor T22 and the third transistor T23.

At the same time, a drive current transmitted to the display unit 203 through the second transistor T22 is: Ids=½k(Vgs−Vth)\hat{d}2, wherein, K=μCox W/L, W is the width of the conducting channel of the second transistor T22, L is the length of the conducting channel, that is, K is a coefficient that is used to represent the size of the conducting channel of the second transistor T22, electron mobility and other relevant parameters.

Furthermore, Vgs is VNs−VNn=Vdd−(Vdata−Vth), then Vgs−Vth=Vdd−(Vdata−Vth)−Vth=Vdd−Vdata+Vth−Vth=Vdd−Vdata.

Obviously, There is no relationship between the drive current Ids used for the OLED D21 of the display unit 203 and the threshold voltage Vth of the second transistor T22. That is, the threshold voltage Vth of the second transistor T22 is offset during the display phase H23 by writing the threshold voltage Vth of the second transistor T22 to the drive node Nn in advance, and the voltage drift of the threshold voltage Vth of the second transistor T22 is eliminated, therefore preventing the luminance of the OLED D21 in the display unit 203 from being unable to reach a predetermined luminance due to the voltage drift the threshold voltage Vth of the second transistor T22.

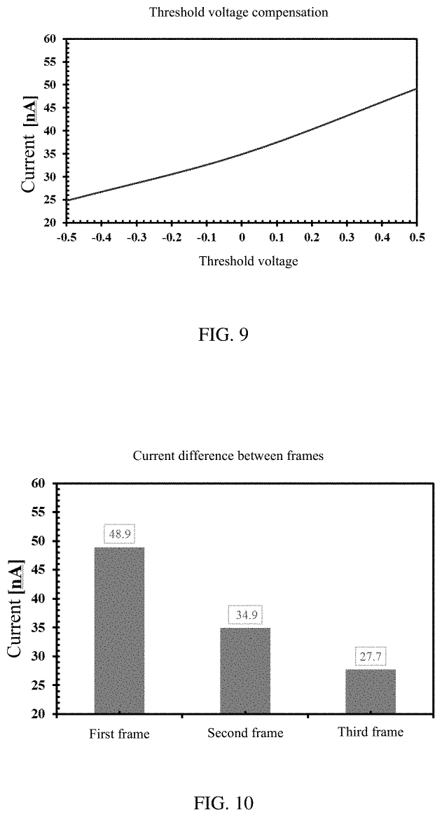

Please refer to FIGS. 9 and 10, FIG. 9 is a curve diagram of a current flowing through a display unit of the pixel unit under the action of different threshold voltages as shown in FIG. 7, and FIG. 10 is a curve diagram of a current of the pixel unit flowing through the display unit in three frames as shown in FIG. 7. As shown in FIGS. 9 and 10, although the pixel unit 200, which uses the N-type thin-film transistors and the P-type thin-film transistors at the same time, can eliminate the influence of threshold voltage on the display unit and reduce the leakage current phenomenon of the drive node Nn theoretically, however, because of the pixel unit 200 lack of a reset unit, the voltage of the drive node Nn is too high, further resulting in the second transistor T22 unable to be switched on and displayed normally, or leading to a large difference of currents between each frame, reducing the actual function of circuits and affecting the display effect.

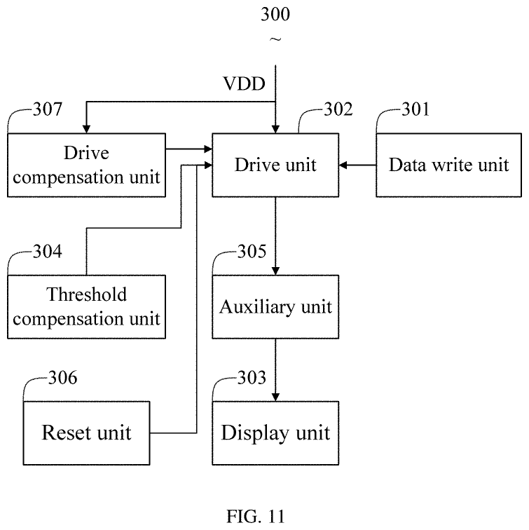

Please refer to FIG. 11, FIG. 11 is a circuit block diagram of a pixel unit in the display panel as shown in FIG. 2 according to a third embodiment of the present disclosure. As shown in FIG. 11, the pixel unit 300 includes a data write unit 301, a drive unit 302, a display unit 303, a threshold compensation unit 304, an auxiliary unit 305, a reset unit 306 and a drive compensation unit 307. In this embodiment, one scanning cycle during a display process of one frame image executed by the pixel unit 300 includes four sequential and continuous time phases of H31-H34. In detail, H31 represents a reset phase, H32 represents a voltage compensation phase, H33 represents a data writing phase, and H34 represents a display phase.

In this embodiment, the data write unit 301 is electrically connected to the drive unit 302, and is configured to write the image data Data to the drive unit 302 according to the first scan signal Gn during the data writing phase H33.

The drive unit 302 is electrically connected to the display unit 303 and is configured to provide a drive current to the display unit 303 in accordance with received emission signal En cooperated with the image data Data during the display phase H34 to drive the display unit 303 to emit light and perform the image display. In this embodiment, the display phase H34 follows the data writing phase H33, and does not overlap completely.

The threshold compensation unit 304 is electrically connected to the drive unit 302, and is configured to provide a compensation voltage to the drive unit 302 during the voltage compensation phase H32. In this embodiment, the compensation voltage is configured to compensate for a voltage drift generated by the drive unit 302 itself when the drive unit 302 provides the drive current to the display unit 303. The voltage compensation phase H32 follows the reset phase H31, and the reset phase H31 and the voltage compensation phase H32 overlap partially.

The drive compensation unit 307 is electrically connected to the drive unit 302, and is configured to provide a drive voltage to the drive unit 302 during the voltage compensation phase H32. In this embodiment, the drive voltage is configured to, in conjunction with the compensation voltage, eliminate the voltage drift generated by the drive unit 302 itself when the drive unit 302 provides the drive current to the display unit 303.

The auxiliary unit 305 is electrically connected between the display unit 303 and the drive unit 302, and is configured to be in an electrical cut-off state under the control of the emission signal En during the reset phase H31, the data writing phase H33 and the voltage compensation phase H32 to enable the display unit 303 and the drive unit 302 to be disconnected, which therefore can prevent the image data Data transmission to the display unit 303 during a non-display phase and further avoid affecting the image display correctly. At the same time, the auxiliary unit 305 is in a conducting state under the control of the emission signal En during the display phase H34, making the display unit 303 and the drive unit 302 be electrically connected, to transmit the drive current to the display unit 303.

The reset unit 306 is electrically connected to the drive unit 302, and is configured to write a reset voltage to the drive unit 302 according to a reset signal during the reset phase H31, so that the drive unit 302 is in an initial drive voltage state; the reset unit 306 is further configured to maintain the voltage of the drive node Nn when the compensation unit 304 is switched on to present the voltage of the drive node Nn from being too high. The reset unit 306 is further configured to make the drive unit 302 complete the reset within the reset phase H31, that is, the reset unit 306 is configured to eliminate the charges remaining in the drive unit 302 in a previous display phase, to ensure that each pixel unit 300 can accurately display the image data during each display phase of one frame images.

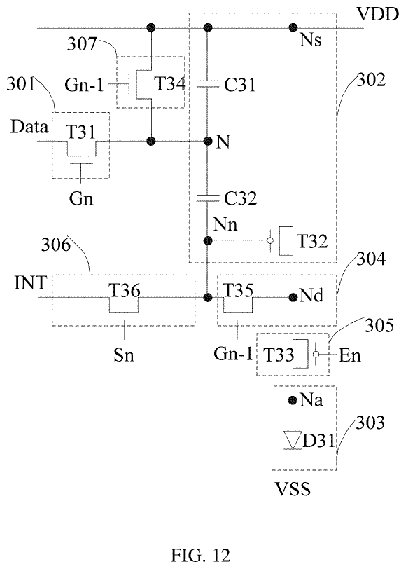

Please refer to FIG. 12, FIG. 12 is a circuit structure diagram of the pixel unit 300 as shown in FIG. 11. As shown in FIG. 11, it should be noted that the pixel unit 300 is scanned and controlled by the scan signal output from the scan line Gn, and transistors in the pixel unit 300 include P-type transistors and N-type transistors. Preferably, in this embodiment, the refresh rate of the pixel unit 300 is 1 Hz-120 Hz, namely, the refresh rate ranges from 1 Hz to 120 Hz. The refresh rate refers to a frequency corresponding to the minimum repetition period of a control signal (CLK) of the pixel unit.

The data write unit 301 includes a first transistor T31 including a gate, a first end and a second end. The gate of the first transistor T31 is electrically connected to a first scan line Gn, the first end of the first transistor T31 is electrically connected to a third node N, and the second end of the first transistor T31 is electrically connected to one of the data lines Dm. In this embodiment, the first transistor T31 is an N-type transistor. The first end of the first transistor T31 is the source of the first transistor T31, and the second end is the drain of the first transistor T31.

In this embodiment, the first transistor T31 is an N-type metal oxide thin-film transistor. In other embodiments, the first transistor T31 can also be a thin-film transistor of N-type semiconductor silicon material. The channel layers of a metal oxide thin-film transistor include, but not limited to, one kind of Indium Gallium Zinc Oxide, Gallium Zinc Oxide, Indium Zinc Oxide, Indium Gallium Tin Oxide and Indium Tin Oxide, or a combination of various metal oxides, or a multilayer film stack of various metal oxides. the leakage current of the N-type metal oxide thin-film transistor is less than 10⁻¹² A. The semiconductor silicon material can, for example, Amorphous Silicon, Monocrystalline Silicon and Polycrystalline Silicon.

The leakage current described in the embodiments is the voltage difference between the gate and the source of the transistor, the threshold voltage Vth is taken as a reference voltage, and the bias voltage between the drain and the source is set within the range of 5-10V when the PN junction in the transistor works in reverse, and then the drain current of the transistor is the leakage current.

Specifically, the leakage current of the N-type metal oxide thin-film transistor is less than 10⁻¹² A. The leakage current depends on the material used in the transistor, if a Low Temperature Poly-Silicon (LTPS) type transistor is used, the leakage current of the P-type transistor is slightly less than that of the N-type transistor; if an IGZO type transistor is used, the leakage current of the P-type transistor and the N-type transistor is small. When the leakage current is larger, the display unit 303 needs to work at a higher frequency. Otherwise, the current will be changed dramatically, that is, the luminance will change unevenly and the power consumption will be high at the high frequency.

The drive unit 302 includes a first capacitor C31, a second capacitor C32 and a second transistor T32. In this embodiment, the second transistor T32 is a P-type thin-film transistor.

The first capacitor C31 is electrically connected between a drive voltage input end VDD and the third node N.

The second capacitor C32 is electrically connected between the third node N and the drive node Nn.

The second transistor T32 includes a gate, a first end and a second end, and the gate of the second transistor T32 is electrically connected to the drive node Nn, the first end of the second transistor T32 is electrically connected to the first node Ns, and the second end of the second transistor T32 is electrically connected to a second node Nd. In this embodiment, the first end of the second transistor T32 is the source of the second transistor T32, and the second end of the second transistor T32 is the drain of the second transistor T32.

The display unit 303 includes an OLED D31, the anode of the OLED D31 is electrically connected to the display node Na, and the cathode of the OLED D31 is electrically connected to the low reference voltage end VSS. Thus, the OLED D31 is located in a conductive path including the drive voltage input end VDD and the low reference voltage end VSS.

The threshold compensation unit 304 includes a fifth transistor T35. The fifth transistor T35 is an N-type thin-film transistor and includes a gate, a first end and a second end. The gate of the fifth transistor T35 is electrically connected to a second scan line Gn−1, the second end of the fifth transistor T35 is electrically connected to the second node Nd, and the first end of the fifth transistor T35 is electrically connected to the drive node Nn. The first end of the fifth transistor T35 is the source of the fifth transistor T35, and the second end of the fifth transistor T35 is the drain of the fifth transistor T35. In this embodiment, the fifth transistor T35 can be an N-type metal oxide thin-film transistor. In other embodiments, the fifth transistor T35 can also be a thin-film transistor of N-type semiconductor silicon material.

The drive compensation unit 307 includes a fourth transistor T34. The fourth transistor T34 is an N-type thin-film transistor and includes a gate, a first end and a second end. The gate of the fourth transistor T34 is electrically connected to the second scan line Gn−1, the second end of the fourth transistor T34 is electrically connected to the drive voltage input end VDD, and the first end of the fourth transistor T34 is electrically connected to the third node N. The first end of the fourth transistor T34 is the source of the fourth transistor T34, and the second end of the fourth transistor T34 is the drain of the fourth transistor T34. In this embodiment, the fourth transistor T34 can be an N-type metal oxide thin-film transistor. In other embodiments, the fourth transistor T34 can also be a thin-film transistor of N-type semiconductor silicon material.

The auxiliary unit 305 includes a third transistor T33, the third transistor T33 is a P-type thin-film transistor and includes a gate, a first end and a second end. The gate of the third transistor T33 is electrically connected to the emission line En, the first end of the third transistor T33 is electrically connected to the second node Nd, and the second end of the third transistor T33 is electrically connected to the display node Na. In this embodiment, the first end of the third transistor T33 is the source of the third transistor T33, and the second end of the third transistor T33 is the drain of the third transistor T33.

The reset unit 306 includes a sixth transistor T36 which is an N-type thin-film transistor. In this embodiment, the sixth transistor T36 is an N-type metal oxide thin-film transistor. In other embodiments, the sixth transistor T36 can also be a thin-film transistor of N-type semiconductor silicon material. The sixth transistor T36 includes a gate, a first end and a second end. The gate of the sixth transistor T36 is electrically connected to a reset scan line Sn, the first end of the sixth transistor T36 is electrically connected to the drive node Nn, and the second end of the sixth transistor T36 is electrically connected to a reset voltage end INT. In this embodiment, the sixth transistor T36 can be used as a reset transistor. The first end of the sixth transistor T36 is the source of the sixth transistor T36, and the second end of the sixth transistor T36 is the drain of the sixth transistor T36.

In this embodiment, the leakage currents of the N-type metal oxide thin-film transistors included in the drive compensation unit 307, the threshold compensation unit 304 and the data write unit 301 are all less than 10⁻¹² A. In addition, the leakage currents of the N-type metal oxide thin-film transistors included in the drive compensation unit 307, the threshold compensation unit 304 and the data write unit 301 are less than the leakage current of the P-type thin-film transistor in the drive unit 302.

In this embodiment, the second scan line Gn−1 and the first scan line Gn are two adjacent scan lines, and can output the scan signals in two adjacent scanning cycles.

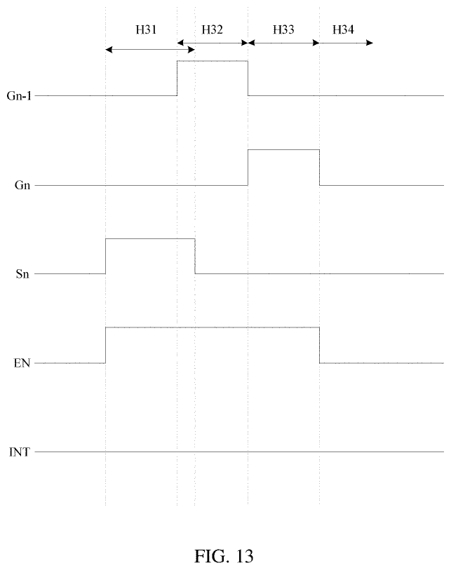

Please refer to FIG. 13, FIG. 13 is a timing diagram during a display process of one frame image by the pixel unit as shown in FIG. 12. As shown in FIG. 13, Gn−1 represents a voltage waveform of the second scan signal Gn−1 output from the second scan line Gn−1, and Gn represents a voltage waveform of the first scan signal Gn output from the first scan line Gn. A curve graph corresponding to Sn represents a waveform of a reset signal Sn output from a reset scan line Sn, and a curve graph corresponding to En represents a voltage waveform of the emission signal En output from the emission line En, and a curve graph corresponding to INT represents a voltage waveform of a reset voltage signal INT output from the reset voltage end INT.

In this embodiment of the present disclosure, the high and low level states of different signals can also be expressed by a first potential and a second potential. That is, the low level state of the signal is represented by the first potential, and the high level state of the signal is represented by the second potential.

In this embodiment, the reset phase H31 is divided into a non-overlapping phase which does not overlap with the voltage compensation phase H32 and an overlapping phase which overlaps with the voltage compensation phase H32.

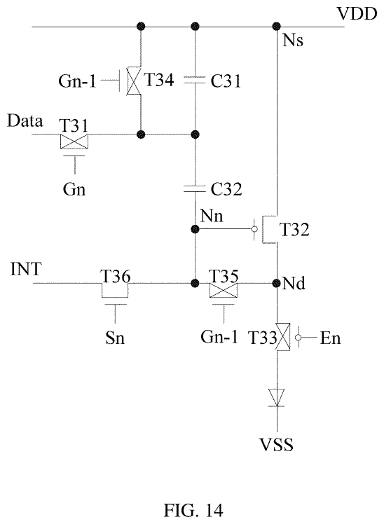

Please refer to FIG. 14, FIG. 14 is a diagram of circuit working condition of the pixel unit in a non-overlapping phase during a reset phase as shown in FIG. 12. As shown in FIG. 14, in the non-overlapping phase, the emission signal En is at the high level, the second scan signal Gn−1 is at the low level, the first scan signal Gn is at the low level, and the reset signal Sn is at the high level. Thus, the third transistor T33 is in the cut-off state under the control of the emission signal En at the high level, the fourth transistor T34 and the fifth transistor T35 are in the cut-off state under the control of the second scan signal Gn−1 at the low level, the first transistor T31 is in the cut-off state under the control of the first scan signal Gn at the low level, and the sixth transistor T36 is in the conducting state under the control of the reset signal Sn at the high level. That is, the third transistor T33 is switched off under the control of the emission signal En at the high level, the fourth transistor T34 and the fifth transistor T35 are switched off under the control of the second scan signal Gn−1 at the low level, the first transistor T31 is switched off under the control of the first scan signal Gn at the low level, and the sixth transistor T36 is switched on under the control of the reset signal Sn at the high level.

Furthermore, since the sixth transistor T36 is in the conducting state under the control of the reset signal Sn at the high level, the reset voltage signal INT output from the reset voltage end INT is transmitted to the drive node Nn in the drive unit 302, which can effectively eliminate the residual voltage in the drive node Nn during the display process of the previous frame images, and ensure that the voltage of the drive node Nn will not affect the operation in the next stage.

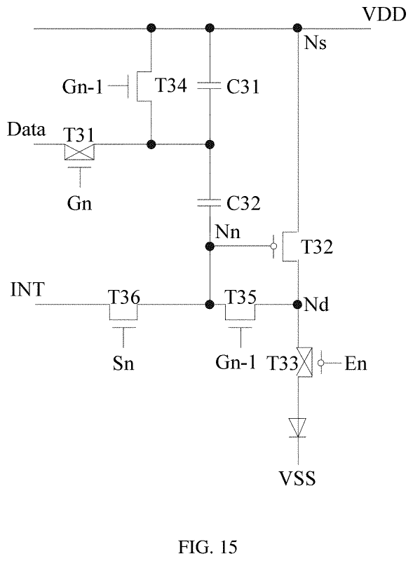

Please refer to FIG. 15, FIG. 15 is a diagram of circuit working condition of the pixel unit in an overlapping phase during the reset phase as shown in FIG. 12. As shown in FIG. 15, in the overlapping phase, the emission signal En is at the high level, the second scan signal Gn−1 is at the high level, the first scan signal Gn is at the low level, and the reset signal Sn is at the high level. Thus, the third transistor T33 is in the cut-off state under the control of the emission signal En at the high level, the fourth transistor T34 and the fifth transistor T35 are in the conducting state under the control of the second scan signal Gn−1 at the high level, the first transistor T31 is in the cut-off state under the control of the first scan signal Gn at the low level, and the sixth transistor T36 is in the conducting state under the control of the reset signal Sn at the high level. That is, the third transistor T33 is switched off under the control of the emission signal En at the high level, the fourth transistor T34 and the fifth transistor T35 are switched on under the control of the second scan signal Gn−1 at the high level, the first transistor T31 is switched off under the control of the first scan signal Gn at the low level, and the sixth transistor T36 is switched on under the control of the reset signal at the high level.

Furthermore, in the overlapping phase, since the fifth transistor T35 is in the conducting state under the control of the second scan signal Gn−1 at the high level, the reset voltage signal INT output from the reset voltage end INT continues to be transmitted to the drive node Nn in the drive unit 302, which can maintain the voltage of the drive node Nn during the period before the threshold compensation unit 304 is switched on and prevent the voltage of the drive node Nn from being too high, therefore ensuring that the voltage of the drive node Nn will not affect the operation in the next stage.

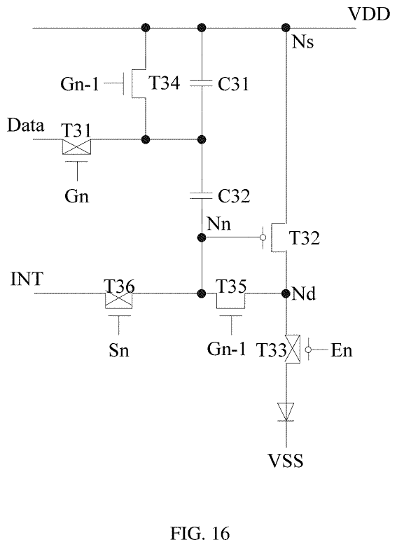

Please refer to FIG. 16, FIG. 16 is a diagram of circuit working condition of the pixel unit in a non-overlapping phase during a voltage compensation phase as shown in FIG. 12. As shown in FIG. 16, in the non-overlapping phase of the voltage compensation phase H32, the emission signal En is at the high level, the second scan signal Gn−1 is at the high level, the first scan signal Gn is at the low level, and the reset signal Sn is at the low level. Thus, the third transistor T33 is in the cut-off state under the control of the emission signal En at the high level, the fourth transistor T34 and the fifth transistor T35 are in the conducting state under the control of the second scan signal Gn−1 at the high level, the first transistor T31 is in the cut-off state under the control of the first scan signal Gn at the low level, and the sixth transistor T36 is in the cut-off state under the control of the reset signal Sn at the low level. That is, the third transistor T33 is switched off under the control of the emission signal En at the high level, the fourth transistor T34 and the fifth transistor T35 are switched on under the control of the second scan signal Gn−1 at the high level, the first transistor T31 is switched off under the control of the first scan signal Gn at the low level, and the sixth transistor T36 is switched off under the control of the reset signal at the low level.

Furthermore, since the fourth transistor T34 is in the conducting state under the control of the second scan signal Gn−1 at the high level, the emission drive voltage Vdd from the drive voltage input end VDD is transmitted to the third node N.

At the same time, under the action of the reset voltage INT, the voltage of the drive node Nn is far less than the emission drive voltage Vdd applied on the first node Ns. That is, the gate voltage of the second transistor T32 is less than that of the source of the second transistor T32, so that the second transistor T32 is in the conducting state.

The fifth transistor T35 is in the conducting state under the control of the second scan signal Gn−1 at the high level, at this point, the gate of the fifth transistor T35 is electrically connected to the drain of the fifth transistor T35, therefore forming a diode connection. Thus, at this point, the voltage VNn of the drive node Nn is charged by the emission drive voltage Vdd through the second transistor T32. When the voltage VNn of the drive node Nn is charged to a voltage Vdd-Vth, the second transistor T32 is in the cut-off state, that is, the second transistor T32 is switched off, the emission drive voltage Vdd stops charging the drive node Nn. Moreover, due to the non-mutagability of the second capacitor C32, the voltage VNn of the drive node Nn is maintained at the voltage Vdd-Vth. Wherein, Vth is the threshold voltage when the second transistor T32 in the conducting state. It can be seen that the threshold voltage Vth of the second transistor T32 is written to the drive node Nn along with the emission drive voltage Vdd, that is, the emission drive voltage Vdd and the threshold voltage Vth of the second transistor T32 are both written to the drive node Nn.

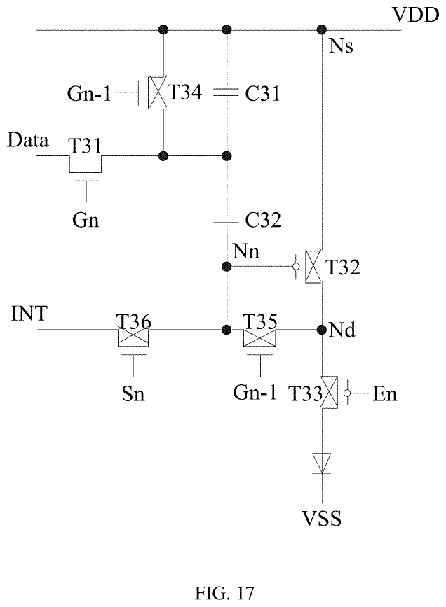

Please refer to FIG. 17, FIG. 17 is a diagram of circuit working condition of the pixel unit during a data writing phase as shown in FIG. 12. As shown in FIG. 17, in the data writing phase H32, the emission signal En is at the high level, the second scan signal Gn−1 is at the low level, and the first scan signal Gn is at the high level. Thus, the third transistor T33 is in the cut-off state under the control of the emission signal En at the high level, the fourth transistor T34 and the fifth transistor T35 are in the cut-off state under the control of the second scan signal Gn−1 at the low level, the first transistor T31 is in the conducting state under the control of the first scan signal Gn at the high level, and the sixth transistor T36 is in the cut-off state under the control of the reset signal Sn at the low level. That is, the third transistor T33 is switched off under the control of the emission signal En at the high level, the fourth transistor T34 and the fifth transistor T35 are switched off under the control of the second scan signal Gn−1 at the low level, the first transistor T31 is switched on under the control of the first scan signal Gn at the high level, and the sixth transistor T36 is switched off under the control of the reset signal Sn at the low level.

Furthermore, since the first transistor T31 is in the conducting state under the control of the first scan signal Gn at the high level, the data voltage Vdata is input to the third node N through the first transistor T31, enabling the voltage VN of the third node N to be Vdd-Vdata.

At the same time, the voltage VNn of the drive node Nn is affected by voltage changes of the third node N, the voltage VNn is changed to Vdd−Vth−(Vdd−Vdata), namely, the voltage VNn of the drive node Nn is Vdata−Vth.

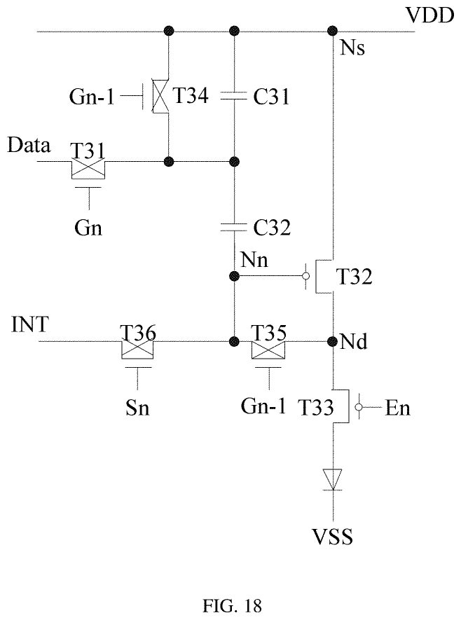

Please refer to FIG. 18, FIG. 18 is a diagram of circuit working condition of the pixel unit during a display phase as shown in FIG. 12. As shown in FIG. 18, in the display phase H34, the emission signal En is at the low level, the second scan signal Gn−1 is at the low level, and the first scan signal Gn is at the low level. Thus, the third transistor T33 is in the conducting state under the control of the emission signal En at the low level, the fourth transistor T34 and the fifth transistor T35 are in the cut-off state under the control of the second scan signal Gn−1 at the low level, and the first transistor T31 is in the cut-off state under the control of the first scan signal Gn at the low level. That is, the third transistor T33 is switched on under the control of the emission signal En at the low level, the fourth transistor T34 and the fifth transistor T35 are switched off under the control of the second scan signal Gn−1 at the low level, and the first transistor T31 is switched off under the control of the first scan signal Gn at the low level.

Furthermore, in the display phase H34, the data write unit 301 stops working, and the voltage of the drive node Nn is Vdata-Vth which is less than the emission drive voltage Vdd of the first node Ns. That is, the gate voltage of the second transistor T32 is less than the voltage applied on the source of the second transistor T32, so that the second transistor T32 is in the conduction state, namely, the second transistor T32 is switched on.

In addition, since the third transistor T33 is in the conducting state under the control of the emission signal En at the low level, so that the emission drive voltage Vdd can be transmitted to the OLED D31 in the display unit 303 through the second transistor T32 and the third transistor T33.

At the same time, a drive current transmitted to the display unit 303 through the second transistor T32 is: Ids=½k(Vgs−Vth)\hat{ }2, wherein, K=μCox W/L, W is the width of the conducting channel of the second transistor T32, L is the length of the conducting channel, that is, K is a coefficient that is used to represent the size of the conducting channel of the second transistor T32, electron mobility and other relevant parameters.

Furthermore, Vgs is VNs−VNn=Vdd−(Vdata−Vth), then Vgs−Vth=Vdd−(Vdata−Vth)−Vth=Vdd−Vdata+Vth−Vth=Vdd−Vdata.

Obviously, There is no relationship between the drive current Ids used for the OLED D31 in the display unit 303 and the threshold voltage Vth of the second transistor T32. That is, the threshold voltage Vth of the second transistor T32 is offset during the display phase H34 by writing the threshold voltage Vth of the second transistor T32 to the drive node Nn in advance, and the voltage drift of the threshold voltage Vth of the second transistor T32 is eliminated, therefore preventing the luminance of the OLED D31 in the display unit 303 from being unable to reach a predetermined luminance due to the voltage drift the threshold voltage Vth of the second transistor T22.

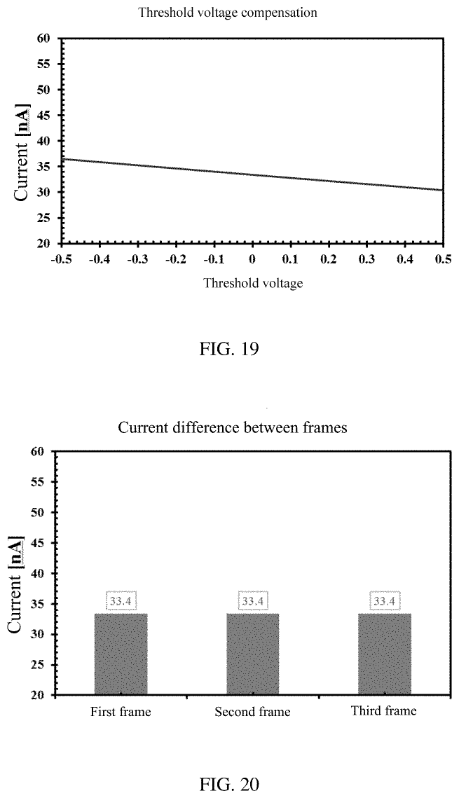

Please refer to FIGS. 19 and 20, FIG. 19 is a curve diagram of a current flowing through the display unit of the pixel unit under the action of different threshold voltages as shown in FIG. 12, and FIG. 20 is a curve diagram of a current of the pixel unit flowing through the display unit in three frames as shown in FIG. 12. As shown in FIGS. 19 and 20, although the pixel unit 300, which adds a reset unit on the basis of the pixel unit 200, can not only eliminate the influence of threshold voltage on the display unit and reduce the leakage current phenomenon of the drive node Nn, but also further reduce the difference of currents between each frame images, therefore enhancing the actual function of circuits and improving the display effect.

Compared with the existing technology, in this embodiment, the P-type thin-film transistors and the N-type thin-film transistors are used in the drive unit 302, the threshold compensation unit 304, the drive compensation unit 307, the auxiliary unit 305 and the data write unit 301, and at the same time, the reset unit 306 is added in the pixel unit 300 to reset the drive unit 302. Thus, not only the leakage current of the pixel unit is reduced, but also the problem of unstable voltage of the drive node in the drive unit is solved, and the power consumption is reduced while the display effect is improved. Furthermore, when the transistors in the drive unit are all P-type low temperature polycrystalline oxide transistors, and the data write unit, the auxiliary unit and the compensation unit use the N-type metal oxide thin-film transistors, therefore, the leakage current of the pixel unit is small overall, and the voltage drift of the pixel unit itself and the display unit can be accurately suppressed, which can effectively reduce the power consumption and have a better display effect. Moreover, the P-type low temperature polycrystalline oxide transistor used in the drive unit has a strong drive ability, which can make the pixel unit quickly adapt to the refresh rate of different image data displayed at high and low speeds. The refresh rate ranges from 1 Hz to 120 Hz. For example, the pixel circuit mixed a high frequency with a refresh rate of 120 Hz and a low frequency with a refresh rate of 10 Hz also has a better display effect.

In this disclosure, a pixel unit, an array substrate an display terminal described in above embodiments are introduced in detail, specific embodiments are used to illustrate the principle and the embodiments of the present disclosure, and the above embodiments are only used to help understand the core idea of the present disclosure. It should be noted that for those of ordinary skill in the art, several improvements and retouches can be made without departing from the principles of the embodiments of the present disclosure, and these improvements and retouches are also regarded as the protection scope of the present disclosure.

What is claimed is:

1. A pixel unit, comprising a drive unit, a display unit, a threshold compensation unit and a reset unit, wherein, the pixel unit receives and displays image data in a scanning cycle within a display period of the n-th frame image, n is a nature number greater than 1;
the drive unit is electrically connected to the display unit and is operable to provide a drive current to the display unit in accordance with an emission signal received and image data received during a display phase of the scanning cycle to drive the display unit to perform image display;
the reset unit is electrically connected to the drive unit and is operable to write a reset voltage to the drive unit according to a reset signal during a reset phase of the scanning cycle to reset the drive unit;
the threshold compensation unit is electrically connected to the drive unit and is operable to provide a compensation voltage to the drive unit during a voltage compensation phase of the scanning cycle under the control of a second scan signal;
wherein, the compensation voltage is operable to compensate for a voltage drift generated by the drive unit when the drive unit provides the drive current to the display unit;
the voltage compensation phase and the reset phase overlap partially.

2. The pixel unit according to claim 1, wherein the reset unit and the threshold compensation unit are electrically connected to the drive unit through a drive node, during a phase where the voltage compensation phase is overlapped with the reset phase, the reset unit controls a voltage of the drive node to be a first potential, and the first potential controls the drive unit to be switched on; a threshold voltage when the drive unit is switched on is taken as a compensation voltage, and the compensation voltage is provided to the drive node.

3. The pixel unit according to claim 2, wherein during a phase where the voltage compensation phase is overlapped with the reset phase, the reset unit transmits the reset voltage to the drive node to control the voltage of the drive node to be the first potential, and the threshold compensation unit takes the threshold voltage as the compensation voltage and provides the compensation voltage to the drive node;
during a non-overlapping phase of the reset phase, the threshold compensation unit does not write the compensation voltage to the drive node, and the reset unit transmits the reset voltage to the drive node to control the voltage of the drive node to be the first potential to reset the drive node;
during a non-overlapping phase of the voltage compensation phase, the reset unit does not write the reset voltage to the drive node, and the threshold compensation unit takes the threshold voltage as the compensation voltage and provides the compensation voltage to the drive node.

4. The pixel unit according to claim 3, wherein the reset unit is in a cut-off state under the control of a first potential of the reset signal and is in a conducting state under the control of a second potential of the reset signal to write the reset voltage to the drive node;
the threshold compensation unit is in a cut-off state under the control of a first potential of the second scan signal and is in a conducting state under the control of a second potential of the second scan signal to write the compensation voltage to the drive node;
during the phase where the voltage compensation phase is overlapped with the reset phase, the reset signal received by the reset unit and the second scan signal received by the threshold compensation unit are both the second potential;
during the non-overlapping phase of the reset phase, the reset signal received by the reset unit is the second potential, and the second scan signal received by the threshold compensation unit is the first potential;
during the non-overlapping phase of the voltage compensation phase, the reset signal received by the reset unit is the first potential, and the second scan signal received by the threshold compensation unit is the second potential.

5. The pixel unit according to claim 1, further comprising a drive compensation unit and a data write unit, wherein,
the data write unit is electrically connected to the drive unit and is operable to write the image data to the drive unit according to a first scan signal during a data writing phase of the scanning cycle;
the drive compensation unit is electrically connected to the drive unit and is operable to provide a drive voltage to the drive unit under the control of the second scan signal during a voltage compensation phase of the scanning cycle; the drive voltage is operable to, in conjunction with the compensation voltage, eliminate a voltage drift generated by the drive unit when the drive unit provides the drive current to the display unit.

6. The pixel unit according to claim 5, further comprising an auxiliary unit, wherein,
the auxiliary unit is electrically connected between the display unit and the drive unit and is operable to be in an electrical cut-off state under the control of the emission signal during the reset phase, the data writing phase and the voltage compensation phase, to control the display unit and the drive unit be disconnected; the auxiliary unit is further operable to be in a conducting state under the control of the emission signal during the display phase to control the display unit and the drive unit be electrically connected, to transmit the drive current to the display unit.

7. The pixel unit according to claim 6, wherein the reset unit comprises a reset transistor, a gate of the reset transistor receives the reset signal, a second end of the reset transistor is electrically connected to a reset voltage end to receive the reset voltage, and a first end of the reset transistor is electrically connected to the drive node; the reset transistor is in the conducting state under the control of a second potential of the reset signal during the reset phase and transmit the reset voltage to the drive node.

8. The pixel unit according to claim 7, wherein the data write unit comprises a first transistor, a gate of the first transistor is operable to receive the first scan signal, a second end of the first transistor is operable to receive the image data, and a first end of the first transistor is electrically connected to a third node; the first transistor is switched on during the data writing phase to write the image data to the drive node.

9. The pixel unit according to claim 8, wherein the drive unit comprises a first capacitor, a second capacitor and a second transistor, a gate of the second transistor is electrically connected to the drive node, a first end of the second transistor is electrically connected to a drive voltage input end through a first node, and a second end of the second transistor is electrically connected to the threshold compensation unit through a second node;
the second transistor is operable to be switched on during the display phase to transmit the drive current to the display unit;
the first capacitor is electrically connected between the first node and the third node, the third node is operable to receive the drive current;
the second capacitor is electrically connected between the third node and the drive node.

10. The pixel unit according to claim 9, wherein the display unit comprises an OLED, an anode of the OLED is electrically connected to a display node, the display node is electrically connected to the second transistor to receive the drive current, a cathode of the OLED is electrically connected to a low reference voltage end, and the OLED is located in a conductive path comprising the drive voltage input end and the low reference voltage end; the OLED emits light driven by the drive current according to the image data during the display phase.

11. The pixel unit according to claim 10, wherein the auxiliary unit comprises a third transistor, a gate of the third transistor receives the emission signal, a first end of the third transistor is electrically connected to the second node, and a second end of the third transistor is electrically connected to the display node; the third transistor is switched on during the display phase to transmit the drive current to the OLED.

12. The pixel unit according to claim 11, wherein the drive compensation unit comprises a fourth transistor, a gate of the fourth transistor receives the second scan signal, a second end of the fourth transistor is electrically connected to the drive voltage input end, and a first end of the fourth transistor is electrically connected to the data write unit through the third node; the fourth transistor is switched on during the voltage compensation phase to write the drive voltage to the drive node.

13. The pixel unit according to claim 12, wherein the threshold compensation unit comprises a fifth transistor, a gate of the fifth transistor receives the second scan signal, a second end of the fifth transistor is electrically connected to the second node, and a first end of the fifth transistor is electrically connected to the drive node; the fifth transistor is switched on during the voltage compensation phase to write the compensation voltage to the drive node.

14. The pixel unit according to claim 5, wherein at least one of thin-film transistors in the reset unit, the drive compensation unit, the threshold compensation unit and the data write unit is an N-type metal oxide thin-film transistor.

15. The pixel unit according to claim 14, wherein the N-type metal oxide thin-film transistor at least comprises one kind of Indium Gallium Zinc Oxide, Gallium Zinc Oxide, Indium Zinc Oxide, Indium Gallium Tin Oxide and Indium Tin Oxide, or a combination of various metal oxides, or a multilayer film stack of various metal oxides.

16. The pixel unit according to claim 5, wherein a leakage current of at least one of thin-film transistors in the reset unit, the drive compensation unit, the threshold compensation unit and the data write unit is less than the leakage current of a drive transistor of the drive unit.

17. The pixel unit according to claim 5, wherein a leakage current of at least one of thin-film transistors in the reset unit, the drive compensation unit, the threshold compensation unit and the data write unit is less than 10⁻¹² A.

18. The pixel unit according to claim 1, wherein when the pixel unit continuously outputs a signal to the display unit, a refresh rate of the pixel unit changes dynamically if changing frequencies of a control signal.

19. An array substrate, comprising a display area, the display area comprising a plurality of pixel units, each pixel unit comprising a drive unit, a display unit, a threshold compensation unit and a reset unit, wherein, the pixel unit receives and displays image data in a scanning cycle within a display period of the n-th frame image, n is a nature number greater than 1;
the drive unit is electrically connected to the display unit and is operable to provide a drive current to the display unit in accordance with an emission signal received and image data received during a display phase of the scanning cycle to drive the display unit to perform image display;
the reset unit is electrically connected to the drive unit and is operable to write a reset voltage to the drive unit according to a reset signal during a reset phase of the scanning cycle to reset the drive unit;
the threshold compensation unit is electrically connected to the drive unit and is operable to provide a compensation voltage to the drive unit during a voltage compensation phase of the scanning cycle under the control of a second scan signal; wherein, the compensation voltage is operable to compensate for a voltage drift generated by the drive unit when the drive unit provides the drive current to the display unit;
the voltage compensation phase and the reset phase overlap partially.

20. A display terminal, comprising an array substrate, the array substrate comprising a display area which comprising a plurality of pixel units, each pixel unit comprising a drive unit, a display unit, a threshold compensation unit and a reset unit, wherein, the pixel unit receives and displays image data in a scanning cycle within a display period of the n-th frame image, n is a nature number greater than 1;
the drive unit is electrically connected to the display unit and is operable to provide a drive current to the display unit in accordance with an emission signal received and image data received during a display phase of the scanning cycle to drive the display unit to perform image display;
the reset unit is electrically connected to the drive unit and is operable to write a reset voltage to the drive unit according to a reset signal during a reset phase of the scanning cycle to reset the drive unit;
the threshold compensation unit is electrically connected to the drive unit and is operable to provide a compensation voltage to the drive unit during a voltage compensation phase of the scanning cycle under the control of a second scan signal;
wherein, the compensation voltage is operable to compensate for a voltage drift generated by the drive unit when the drive unit provides the drive current to the display unit;
the voltage compensation phase and the reset phase overlap partially.
